(19) United States
(12) Patent Application Publication
(10) Pub. No.: US 2026/0276455 A1
(43) Pub. Date: Sep. 17, 2026

(54) METHOD FOR ASCERTAINING THE TESTABILITY OF A THERMAL SYSTEM

(71) Applicant: Robert Bosch GmbH, Stuttgart (DE)

(72) Inventors: Peter Bakucz, Klosterlechfeld (DE); Anna Katharina Stirm, Marbach (DE); Armin Fortwingel, Abstatt (DE)

(21) Appl. No.: 19/561,054

(22) Filed: Mar. 9, 2026

(30) Foreign Application Priority Data
Mar. 12, 2025 (DE) 10 2025 109 384.9

(51) Int. Cl. G01K 3/14

(52) U.S. Cl. CPC G01K 3/14; G01K 2213/00

(57) ABSTRACT

A computer-implemented method for ascertaining the testability of a thermal system. The method includes: receiving thermal conductivity values of the thermal system; ascertaining a dynamic behavior of the thermal system based on the thermal conductivity values; ascertaining a linearity of the thermal behavior of the thermal system; and identifying the thermal system as testable if the thermal behavior is identified as a linear thermal behavior; and identifying the thermal system as non-testable if the thermal behavior is identified as a non-linear thermal behavior. A method for testing a thermal system.

### CROSS REFERENCE

The present application claims the benefit under 35 U.S.C. § 119 of Germany Patent Application No. DE 10 2025 109 384.9 filed on Mar. 12, 2025, which is expressly incorporated herein by reference in its entirety.

### FIELD

The present disclosure relates to a method for ascertaining the testability of a thermal system.

### BACKGROUND INFORMATION

Certain methods for ascertaining the testability of thermal systems are described in the related art.

It is an object of the present disclosure to provide an improved method for ascertaining the testability of a thermal system and an improved method for testing a thermal system.

### SUMMARY

The object may be achieved by methods having certain features of the present disclosure. Advantageous embodiments are disclosed herein.

According to one aspect of the present disclosure, a computer-implemented method for ascertaining the testability of a thermal system is provided. According to an example embodiment, the method comprises:
receiving thermal conductivity values of the thermal system;
ascertaining a dynamic behavior of the thermal system based on the thermal conductivity values;
ascertaining a linearity of the thermal behavior of the thermal system; and
identifying the thermal system as testable if the thermal behavior is identified as a linear thermal behavior; and
identifying the thermal system as non-testable if the thermal behavior is identified as a non-linear thermal behavior.

As a result, this can achieve a technical advantage that an improved method for ascertaining the testability of a thermal system can be provided. For this purpose, initially, a dynamic behavior of the thermal system is ascertained based on thermal conductivity values of the thermal system. Thereafter, the linearity of the thermal behavior is ascertained. Thereafter, the testability of the thermal system is ascertained based on linearity of the thermal behavior. The thermal system is identified as testable if the thermal behavior is a linear behavior. By contrast, the thermal system is identified as not testable if the thermal behavior is not linear.

By ascertaining the linearity of the thermal behavior, the testability of the thermal system can be ascertained. In comparison to complex simulation tools, which are used to exactly map thermal behavior in order to ascertain whether or not the thermal system is testable, the present method requires substantially lower computational capacity and calculation time.

Within the meaning of the present disclosure, the testability of the thermal system describes whether a thermal test of the thermal system can be performed and/or is meaningful. Here, a thermal test of a thermal system is meaningful if it is to be assumed that the thermal behavior of the present thermal system will remain within predefined framework conditions for thermal behavior of thermal systems of the same type.

If, by contrast, according to the present disclosure it is ascertained that the thermal behavior of the thermal system to be examined comprises non-linear components, then it cannot be predicted how the thermal system to be examined will behave during the thermal test. In such a case, performing a thermal test is to be assessed as not meaningful.

The method according to the present disclosure thus enables a precise assessment of the testability of a thermal system to be tested based on the linearity of the thermal behavior of the thermal system. The method according to the present disclosure requires, for this purpose, a substantially lower computational effort than is the case for conventional simulation methods.

Here, the dynamic behavior of the thermal system is, within the meaning of the present application, a temporal evolution of the dynamic properties of the dynamic system.

According to an example embodiment, ascertaining the dynamic behavior comprises:
ascertaining a heat flow within the thermal system for a plurality of boundary conditions and/or initial values and generating, for the plurality of boundary conditions and/or initial values, a plurality of heat flow trajectories describing the heat flow, wherein the heat flow is ascertained taking into account the thermal conductivity values of the thermal system.

As a result, this can achieve the technical advantage that, based on the heat flow of the thermal system, a precise ascertainment of the thermal behavior of the thermal system is enabled.

By generating heat flow trajectories, different cases of the temporal evolution of the dynamic behavior of the thermal system can be ascertained for different initial values and boundary conditions. This allows for a precise and detailed examination of the dynamic behavior.

According to an example embodiment, the boundary conditions comprise at least one from the following list: number of thermal components of the thermal system, size of the thermal components, interaction of the thermal components relative to one another, thermal properties of the thermal components; and/or wherein the initial values comprise initial temperatures of the thermal system.

As a result, this can achieve the technical advantage that, through the different boundary conditions and/or initial values, meaningful solutions of the different cases of the dynamic behavior can be provided in the form of the corresponding heat flow trajectories.

According to an example embodiment, ascertaining the linearity of the thermal behavior comprises:
carrying out an attractor analysis of the plurality of heat flow trajectories.

As a result, this can achieve the technical advantage that, due to the attractor analysis of the heat flow trajectories, a precise ascertainment of the linearity of the dynamic behavior can be provided. Here, the analysis of attractors of the plurality of heat flow trajectories representing the dynamic behavior enables an analysis of the linearity of the dynamic behavior that is precise, fast and saves computational capacity.

According to an example embodiment, carrying out the attractor analysis comprises:
mapping the heat flow trajectories into a multidimensional phase space and generating phase space trajectories within the phase space;
ascertaining correlation dimensions of the phase space trajectories;
identifying the thermal behavior as a non-linear behavior if the correlation dimension of the phase space trajectories is greater than or equal to a predefined threshold value; and
identifying the thermal behavior as a linear behavior if the correlation dimension is less than the predefined threshold value.

As a result, this can achieve the technical advantage that, due to calculation of the correlation dimension of the phase space trajectories, a precise attractor analysis and, associated therewith, a precise analysis of the linearity of the dynamic behavior can be provided.

Here, the dynamic behavior is identified as a linear behavior if the correlation dimension is less than a predefined threshold value. If the correlation dimension is, by contrast, greater than or equal to the predefined threshold value, then the dynamic behavior is identified as non-linear.

The calculation of the correlation dimension of the phase space trajectories in turn enables an analysis of the linearity of the dynamic behavior that is fast, precise and saves computational capacity.

Here, the correlation dimension is, within the meaning of the present application, a designation for the fractal dimension, and designates the roughness (non-linearity) of a signal that is self-similar.

According to an example embodiment, the heat flow trajectories are mapped into the phase space using time-delay coordinates.

As a result, this can achieve the technical advantage that, through mapping the heat flow trajectories into the phase space using time-delay coordinates, a precise calculation of the correlation dimensions of the phase space trajectories is enabled.

According to an example embodiment, ascertaining the thermal behavior comprises:
dividing the thermal system into a plurality of spatial elements; and
calculating the heat flow for the plurality of spatial elements.

As a result, this can achieve the technical advantage that, through dividing the thermal system into a plurality of spatial elements and calculating the heat flow for the plurality of spatial elements, a precise ascertainment of the heat flow of the entire thermal system is enabled.

In addition, dividing the thermal system into a plurality of spatial regions and calculating the heat flow for each spatial region individually enables a reduction of the complexity of the calculation of the heat flow. This can further reduce the required computational capacity.

According to an example embodiment, the thermal behavior is ascertained taking into account Fourier's law of heat flow.

As a result, this can achieve the technical advantage that a precise ascertainment of the dynamic behavior based on the heat flow of the thermal system is enabled. For this purpose, Fourier's law can be taken into account in the form of a differential equation.

According to an example embodiment, the thermal conductivity values are ascertained according to thermal components formed in the thermal system.

As a result, this can achieve the technical advantage that a precise description of the thermal system to be examined based on the thermal conductivity values is enabled.

According to an example embodiment, the thermal system is formed by an electronic printed circuit board for a vehicle.

As a result, this can achieve the technical advantage that the testability of an electronic printed circuit board for a vehicle can be performed by means of the present method. For the thermal load capacity of printed circuit boards in the vehicle field, in particular for use in autonomous driving, precise threshold values are specified which restrict the dynamic behavior of the respective electronic components.

By means of the method according to the present disclosure, the printed circuit board to be checked can be analyzed regarding whether the threshold values or specifications that restrict the dynamic behavior of the printed circuit board can be complied with. If the dynamic behavior of the printed circuit board to be examined is, by contrast, identified as a non-linear behavior, it is to be assumed that the specified threshold values and/or guidelines, with respect to the thermal evolution within a printed circuit board for a vehicle, cannot be complied with.

In such a case, complex thermal testing of the printed circuit board can be omitted, since it is to be assumed that the printed circuit board to be tested will not pass the test prerequisites.

According to one aspect, a method for testing a thermal system is provided, comprising:
ascertaining the testability of the thermal system by carrying out the method for ascertaining the testability of a thermal system according to one of the aforementioned embodiments,
carrying out a thermal test of the thermal system if the thermal system is identified as testable; and
omitting the thermal test of the thermal system if the thermal system is identified as non-testable.

According to one aspect, a computing unit is provided that is configured to perform the method for ascertaining the testability of a thermal system according to one of the aforementioned embodiments and/or to perform the method for testing a thermal system.

According to one aspect, a computer program product comprising commands is provided that, when the program is executed by a data processing unit, cause the data processing unit to perform the method for ascertaining the testability of a thermal system according to one of the aforementioned embodiments and/or to perform the method for testing a thermal system.

Example embodiments of the present disclosure are described with reference to the figures.

### BRIEF DESCRIPTION OF THE DRAWINGS

FIG. 1 is a schematic representation of a method for ascertaining the testability of a thermal system according to an example embodiment.

FIG. 2 is a graphical representation of an attractor analysis of phase space trajectories of the thermal system according to a further example embodiment.

FIG. 3 shows a flow chart of the method for ascertaining the testability of a thermal system according to an example embodiment.

FIG. 4 shows a further flow chart of the method for ascertaining the testability of a thermal system according to a further example embodiment;

FIG. 5 shows a further flow chart of the method for ascertaining the testability of a thermal system according to a further example embodiment.

FIG. 6 shows a flow chart of a method for testing a thermal system according to an example embodiment.

FIG. 7 is a schematic representation of a computer program product, according to an example embodiment.

### DETAILED DESCRIPTION OF EXAMPLE EMBODIMENTS

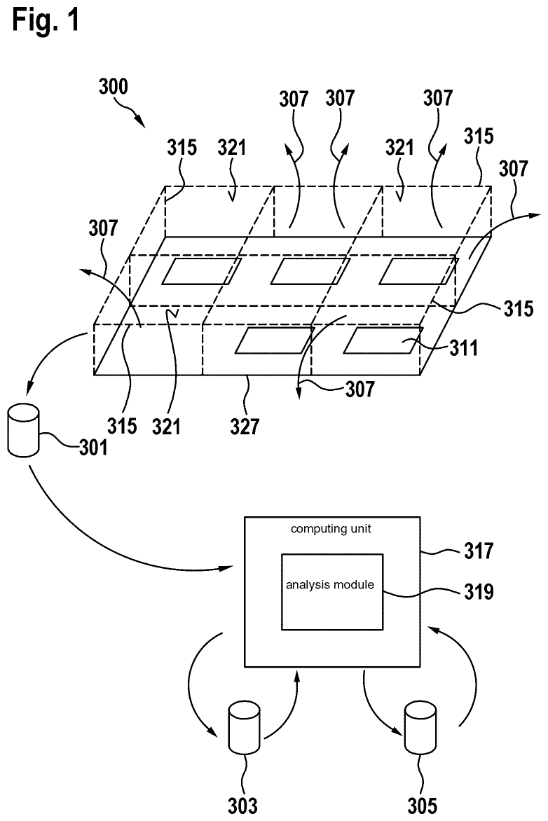

FIG. 1 is a schematic representation of a method for ascertaining the testability of a thermal system 300 according to an embodiment.

FIG. 1 illustrates individual method steps of the method according to the present disclosure for ascertaining the testability of a thermal system 300.

For ascertaining the testability, initially, thermal conductivity values 301 of the thermal system 300 to be checked are received by an analysis module 319 executable on a computing unit 317.

Based on the thermal conductivity values 301, thereafter the analysis module 319 ascertains a dynamic behavior 303 of the thermal system 300 to be examined. Here, the dynamic behavior 303 describes a temporal evolution of thermal properties of the dynamic system 300.

Thereafter, the analysis module 319 ascertains the linearity 305 of the dynamic behavior 303 of the thermal system 300.

Here, the thermal system 300 to be examined is identified as testable if the dynamic behavior 303 is identified as linear behavior. If the dynamic behavior 303 is, by contrast, identified as a non-linear behavior, the thermal system 300 to be examined is classified as not testable.

According to the present application, the testability of a thermal system 300 to be examined is equated with the linearity of the particular dynamic behavior of the thermal system. Correspondingly, the non-testability is equated with the non-linearity of the dynamic behavior.

In the embodiment shown, the thermal system 300 to be examined comprises a plurality of thermal components 309. Here, the thermal conductivity values 301 of the thermal system 300 describe the thermal conductivity properties of the various components 311.

According to the embodiment shown, the dynamic behavior 303 of the thermal system 300 to be examined is ascertained taking into account a heat flow 307 of the thermal system 300.

Here, the heat flow 307 describes an amount of heat that is emitted from the thermal system 300 per unit of time through a unit area.

In the embodiment shown, for ascertaining the dynamic behavior 303, taking into account the heat flow 307, the thermal system to be examined is divided into a plurality of spatial regions 315.

Here, the spatial regions 315 span the thermal system 300 and comprise a plurality of surface elements 321. In the embodiment shown, the heat flow 307 of the thermal system is calculated for the plurality of spatial regions 315.

In particular, the heat flow for each individual spatial region 315 can be calculated, in particular as an amount of heat that flows through the respectively defined surface elements 321 of the particular spatial region 315 per unit of time.

According to an embodiment, for ascertaining the dynamic behavior, the heat flow 307 within the thermal system 300 can be calculated for a plurality of different boundary conditions and/or initial values.

For this purpose, a plurality of heat flow trajectories describing the heat flow 307 can be calculated for the different boundary conditions and/or initial values. Here, the individual heat flow trajectories each describe a temporal evolution of the heat flow for the respectively specified boundary conditions and/or initial values.

Boundary conditions can comprise at least one from the following list: number of thermal components 311 of the thermal system 300, size of the thermal components 311, interaction of the thermal components relative to one another, thermal properties of the thermal components 311.

Different initial temperatures of the thermal system 300 can be used, for example, as initial values.

In the embodiment shown, the thermal system 300 is formed as a printed circuit board 327 for a vehicle. Here, the plurality of thermal components 311 can be individual electronic components of the printed circuit board 327.

According to the particular configuration of the individual components, different thermal conductivity values 301 can be provided for the various spatial regions 315 of the printed circuit board 327.

The thermal conductivity values 301 can be generated, for example, by corresponding measurements of the various components 311 of the thermal system 300.

Deviating from the embodiment shown, the method according to the present disclosure can, however, also be applied to other thermal systems 300. The present disclosure is not intended to be limited to printed circuit boards 327.

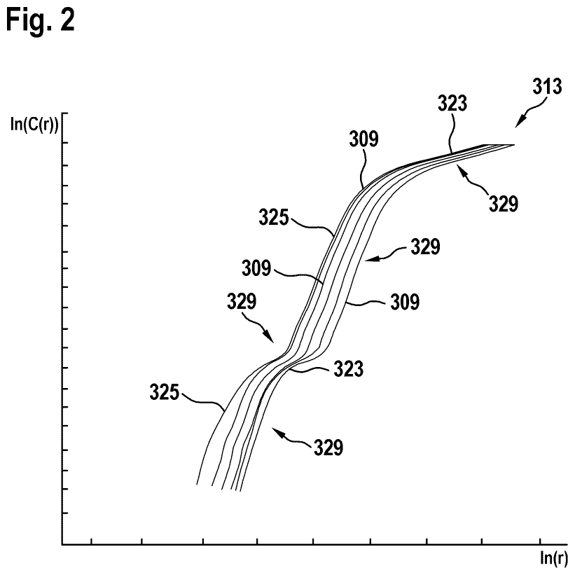

FIG. 2 is a graphical representation of an attractor analysis of phase space trajectories 309 of the thermal system 300 according to a further embodiment.

According to an embodiment, for ascertaining the dynamic behavior 303, the calculation of the heat flow 307 is calculated using Fourier's law of heat flow.

$$\frac{\partial Y}{\partial x} = \frac{k S \frac{\partial T}{\partial x}}{h} \partial t$$

where:
ΔY [J]=∂Y∂x—is the amount of heat that flows through the surface
S [m2] per unit of time
time τ [s]=∂t with
temperature gradient ΔT [K]=∂T∂x, where
k [W/(mK)]—, is a thermal conductivity coefficient, and
h [m] is a layer thickness.

The specific equilibrium energy q (J/kg) is correlated with the unit volume temperature.

$$q = \frac{Y}{h ρ S}$$

Taking into account Fourier's law, a precise heat flow 307 can be calculated for the thermal system 300 to be examined. As already mentioned above, the heat flow 307 can, here, be calculated for each individual spatial region 315.

According to the embodiment shown, for the different boundary conditions and/or initial values, a plurality of heat flow trajectories are calculated taking into account Fourier's law of heat flow 307. Here, the heat flow trajectories describe the temporal evolution of the dynamic properties of the system to be examined and, in their entirety, describe the dynamic behavior 303 of the thermal system 300.

In the shown embodiment, for ascertaining the linearity 305 of the dynamic behavior 303, an attractor analysis of the plurality of heat flow trajectories is performed.

For this purpose, the plurality of heat flow trajectories are mapped into a multidimensional phase space 313 using time-delay coordinates, and corresponding phase space trajectories 309 are generated.

For carrying out the attractor analysis, in the embodiment shown, correlation dimensions of the phase space trajectories 309 in the phase space 313 are ascertained.

For this purpose, the correlation dimension is calculated using a correlation integral.

The correlation integral:

$$C ( r ) = {lim}_{N \to ∞} \frac{1}{{N}^{2}} f$$

where, here, f is the number of pairs of phase space points of the phase space trajectories 309 in the phase space 313, the pairwise distance of which relative to one another is less than or equal to r.

Here, the correlation dimension D results from the following relation:

$$C ( r ) ∼ {r}^{D} ,$$

where this relation applies in particular for small distances r.

In FIG. 2, a log-log representation of a plurality of phase space trajectories 309 is shown. Here, the various phase space trajectories 309 were ascertained based on heat flow trajectories, which were each ascertained for different boundary conditions and/or initial values and represent the temporal evolution of the heat flow.

For ascertaining the linearity of the dynamic behavior 303, the correlation dimensions d are now ascertained for various regions 329 within the phase space 313.

By way of example, four different regions 329 are shown in FIG. 2. Here, two attractor regions 323 and two divergence regions 325 are marked.

Here, the attractor regions 323 are characterized in that the phase space points of the shown phase space trajectories 309 have a small distance r relative to one another and are shown densely packed next to one another.

The divergence regions 325 are, by contrast, characterized in that the phase space points of the shown phase space trajectories 309 have a relatively large distance r relative to one another.

Here, the attractor regions 323 show that the various phase space trajectories 309, which are based on heat flow trajectories, which in each case represent different solutions of the Fourier equation for different framework conditions and/or initial values, are drawn together to a point and/or converge on said point.

The divergence regions show, by contrast, that the phase space trajectories 309 are arranged with respectively larger distances relative to one another and thus have a rather divergent behavior.

When ascertaining the correlation dimension D, the linearity 305 of the dynamic behavior 303 is now ascertained in such a way that, for phase spatial regions 325 in which the correlation dimension D is less than a predefined threshold value, the dynamic behavior 303 is identified as a linear behavior.

In FIG. 2, such linear behavior are ascertained within the marked attractor regions 323.

For spatial regions 325 in which the correlation dimension D is, by contrast, greater than or equal to the predefined threshold value, the dynamic behavior 303 is, by contrast, identified as a non-linear behavior. Such a non-linear behavior is to be expected in the divergence regions 325 shown.

Experiments have shown that, for thermal systems 300 that are, in particular, formed as printed circuit boards 327 for vehicles, the predefined threshold value of the correlation dimension D is equal to 1.28.

In the example shown in FIG. 2, the dynamic behavior 303 represented by the shown phase space trajectories 309 would be identified as a linear behavior in the attractor regions 323 and as a non-linear behavior in the divergence regions 325. Thus, the corresponding thermal system 300 would be identified as not testable for the divergence regions 325 and as testable for the attractor regions 323.

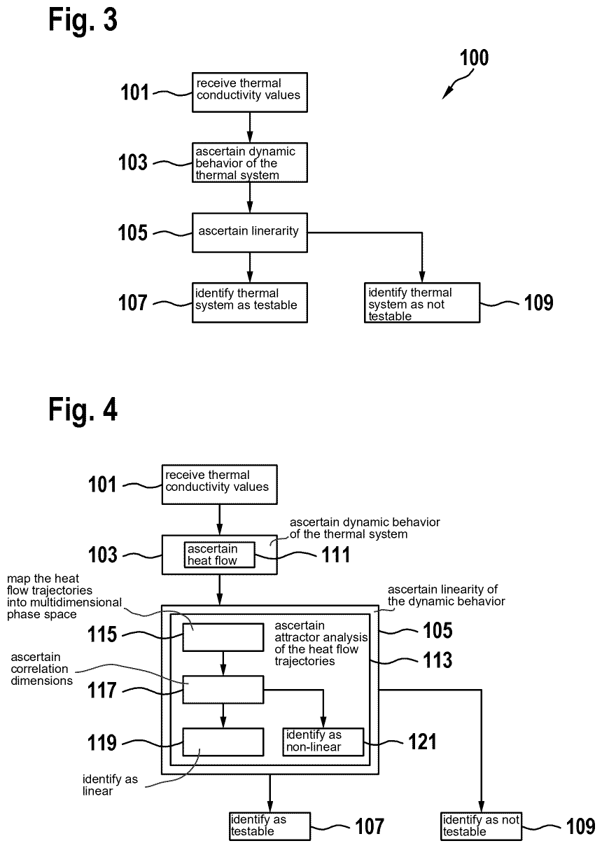

FIG. 3 shows a flow chart of the method 100 for ascertaining the testability of a thermal system 300 according to an embodiment.

For ascertaining the testability of the thermal system 300, in a method step 101, initially, the thermal conductivity values 301 are received. In a method step 103, the dynamic behavior 303 of the thermal system 300 is ascertained based on the thermal conductivity values 301.

In a method step 105, the linearity 305 of the dynamic behavior 303 is ascertained.

In a method step 107, the thermal system 300 is identified as testable if the dynamic behavior 303 is identified as a linear behavior.

In a method step 109, the thermal system 300 is, by contrast, identified as not testable if the dynamic behavior 303 is identified as non-linear.

FIG. 4 shows a further flow chart of the method 100 for ascertaining the testability of a thermal system 300 according to a further embodiment.

The embodiment in FIG. 4 is based on the embodiment in FIG. 3 and comprises all method steps described there.

In the embodiment shown, in a method step 111, for ascertaining the dynamic behavior 303, the heat flow 307 of the thermal system 300 is ascertained.

For ascertaining the linearity 305 of the dynamic behavior 303, in a method step 113, an attractor analysis of the heat flow trajectories ascertained for the plurality of different framework conditions and/or initial values is performed.

For this purpose, in a method step 115, the heat flow trajectories are mapped into a multidimensional phase space 313 using time-delay coordinates, and phase space trajectories 309 are generated in the phase space 313.

In a method step 117, correlation dimensions D are ascertained for the plurality of phase space trajectories 309 in the phase space 313.

In a method step 119, the dynamic behavior 303 is identified as a linear behavior if the correlation dimension D falls below a predefined threshold value.

In a method step 121, the dynamic behavior 303 is, by contrast, identified as a non-linear behavior if the correlation dimension D is greater than or equal to the predefined threshold value.

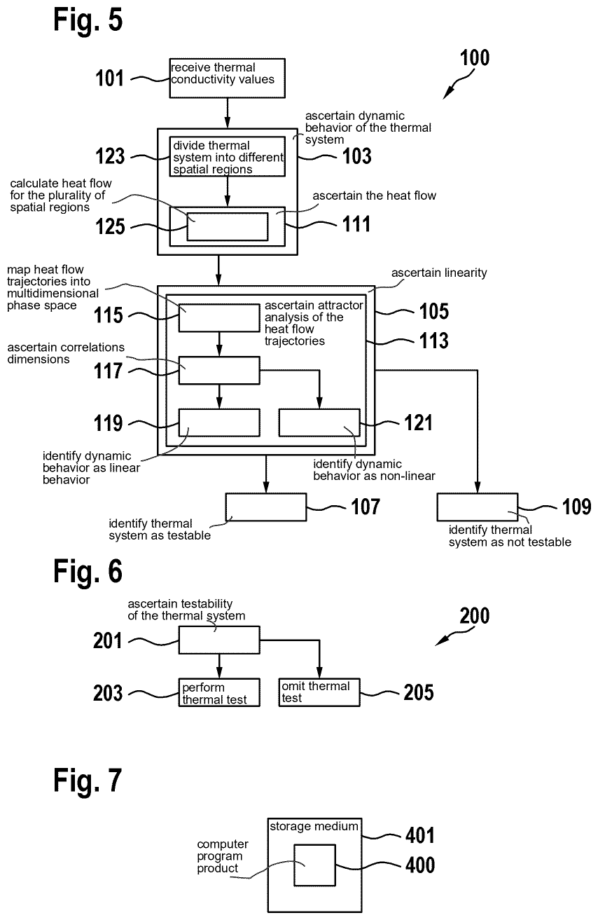

FIG. 5 shows a further flow chart of the method 100 for ascertaining the testability of a thermal system 300 according to a further embodiment.

The embodiment in FIG. 5 is based on the embodiment in FIG. 4 and comprises all the method steps described there.

In the embodiment shown, in a method step 123, for ascertaining the dynamic behavior 103, the thermal system 300 is divided into different spatial regions 315.

In a method step 125, the heat flow 307 is calculated for the plurality of spatial regions 315 of the thermal system 300.

FIG. 6 shows a flow chart of a method 200 for testing a thermal system 300 according to an embodiment.

For testing the thermal system 300, in a first method step 201, initially, the testability of the thermal system 300 is ascertained by performing the method 100 according to the present disclosure for ascertaining the testability of a thermal system 300.

In a further method step 203, a thermal test of the thermal system 300 is performed if the thermal system 300 was identified as testable.

In a further method step 205, the thermal test is, by contrast, omitted if the thermal system 300 was identified as not testable.

Testing the thermal system 300 can, for this purpose, comprise, for example, applying an underload to the thermal system 300 to be tested and measuring the thermal evolution of the thermal system 300 over time.

Here, in particular, the thermal evolutions of individual components 311 of the thermal system 300 can be taken into account by recording corresponding measured values of the temperature evolution.

FIG. 7 is a schematic representation of a computer program product 400, comprising commands that, when the program is executed by a data processing unit, cause the data processing unit to perform the method 100 for ascertaining the testability of a thermal system 300 and/or the method 200 for testing a thermal system 300.

In the embodiment shown, the computer program product 400 is stored on a storage medium 401. The storage medium 401 can be any storage medium known from the prior and/or related art.

What is claimed is:

1. A computer-implemented method for ascertaining the testability of a thermal system, comprising the following steps:
receiving thermal conductivity values of the thermal system;
ascertaining a dynamic behavior of the thermal system based on the thermal conductivity values;
ascertaining a linearity of the dynamic behavior of the thermal system;
identifying the thermal system as testable when the dynamic behavior is identified as a linear thermal behavior; and
identifying the thermal system as non-testable when the dynamic behavior is identified as a non-linear thermal behavior.

2. The method according to claim 1, wherein the ascertaining of the dynamic behavior includes:
ascertaining a heat flow within the thermal system for a plurality of boundary conditions and/or initial values, and
generating, for the plurality of boundary conditions and/or initial values, a plurality of heat flow trajectories describing the heat flow,
wherein the heat flow is ascertained taking into account the thermal conductivity values of the thermal system.

3. The method according to claim 2, wherein at least one of:
the boundary conditions include at least one from the following list:
number of thermal components of the thermal system,
size of the thermal components,
interaction of the thermal components relative to one other, thermal properties of the thermal components, or
the initial values comprise initial temperatures of the thermal system.

4. The method according to claim 2, wherein the ascertaining of the linearity of the dynamic behavior includes:
carrying out an attractor analysis of the plurality of heat flow trajectories.

5. The method according to claim 4, wherein the carrying out of the attractor analysis includes:
mapping the heat flow trajectories into a multidimensional phase space and generating phase space trajectories within the phase space;
ascertaining correlation dimensions for the plurality of phase space trajectories;
identifying the dynamic behavior as a linear behavior when the correlation dimensions of the phase space trajectories are smaller than a predefined threshold value; and
identifying the dynamic behavior as a non-linear behavior when the correlation dimension is greater than or equal to the predefined threshold value.

6. The method according to claim 5, wherein the heat flow trajectories are mapped into the phase space using time-delay coordinates.

7. The method according to claim 1, wherein the ascertaining of the dynamic behavior includes:
dividing the thermal system into a plurality of spatial regions; and
calculating the heat flow for the plurality of spatial regions.

8. The method according to claim 1, wherein the dynamic behavior is ascertained taking into account Fourier's law of heat flow.

9. The method according to claim 1, wherein the thermal conductivity values are ascertained according to the thermal components formed in the thermal system.

10. The method according to claim 1, wherein the thermal system is formed by an electronic printed circuit board for a vehicle.

11. A method for testing a thermal system, the method comprising:
ascertaining a testability of the thermal system by:
receiving thermal conductivity values of the thermal system,
ascertaining a dynamic behavior of the thermal system based on the thermal conductivity values;
ascertaining a linearity of the dynamic behavior of the thermal system,
identifying the thermal system as testable when the dynamic behavior is identified as a linear thermal behavior, and
identifying the thermal system as non-testable when the dynamic behavior is identified as a non-linear thermal behavior;
carrying out a thermal test of the thermal system when the thermal system is identified as testable; and
omitting the thermal test of the thermal system when the thermal system is identified as non-testable.

12. A computing unit that is configured to carry out a method for testing an electronic printed circuit board, the method comprising the following steps:
ascertaining the testability of a thermal system, comprising the following steps:
receiving thermal conductivity values of the thermal system,
ascertaining a dynamic behavior of the thermal system based on the thermal conductivity values;
ascertaining a linearity of the dynamic behavior of the thermal system,
identifying the thermal system as testable when the dynamic behavior is identified as a linear thermal behavior, and
identifying the thermal system as non-testable when the dynamic behavior is identified as a non-linear thermal behavior;
wherein the thermal system is the electronic printed circuit board.

13. A non-transitory computer program including a program including commands for ascertaining the testability of a thermal system, the commands, when executed by a data processor, causing the data processor to perform the following steps:
receiving thermal conductivity values of the thermal system;
ascertaining a dynamic behavior of the thermal system based on the thermal conductivity values;
ascertaining a linearity of the dynamic behavior of the thermal system;
identifying the thermal system as testable when the dynamic behavior is identified as a linear thermal behavior; and
identifying the thermal system as non-testable when the dynamic behavior is identified as a non-linear thermal behavior.
